(19) United States
(12) Patent Application Publication
(10) Pub. No.: US 2015/0355035 A1
(43) Pub. Date: Dec. 10, 2015

(54) IN-PACKAGE TEMPERATURE SENSOR AND METHODS THEREFOR

(71) Applicant: Intel Corporation, Santa Clara, CA (US)

(72) Inventors: Feras Eid, Chandler, AZ (US); Sasha Oster, Chandler, AZ (US); Sarah Haney, Cary, NC (US); Kyu Oh Lee, Chandler, AZ (US)

(21) Appl. No.: 14/296,782

(22) Filed: Jun. 5, 2014

(51) Int. Cl. G01K 11/26

(52) U.S. Cl. CPC G01K 11/26

(57) ABSTRACT

This disclosure relates generally to an electronic assembly and methods that include a dielectric material forming a cavity, a magnet positioned to induce a magnetic field within the cavity, a conductive trace positioned, at least in part, within the cavity, and a frequency detection circuit configured to detect the frequency of the maximal electromotive force as induced and produce an output proportional to a temperature of the conductive trace. The conductive trace resonates within the cavity based on a temperature-dependent resonant frequency of the conductive trace and a sinusoidal current induced through the conductive trace by a current source, the sinusoidal current induces a maximal electromotive force when a frequency of the sinusoidal current has an approximately equal magnitude to the temperature-dependent resonant frequency of the conductive trace, and the maximal electromotive force, as induced, has a substantially equal frequency as the temperature-dependent resonant frequency of the conductive trace.

### TECHNICAL FIELD

The disclosure herein relates generally to a temperature sensor in a chip package and methods therefor.

### BACKGROUND

Temperature sensors may be formed in various locations in microelectronic assemblies utilizing a variety of technologies. For instance, temperature sensors have been positioned within a silicon die and have been positioned on or incorporated into a printed circuit board (PCB). Such temperature sensors thus provide temperature indications pertaining to the components or areas in which the temperature sensors have been incorporated.

### BRIEF DESCRIPTION OF THE DRAWINGS

FIG. 1 shows an abstract microelectronic assembly including a temperature sensor, in an example embodiment.

FIGS. 2A-2E are top and side views of temperature sensors, in example embodiments.

FIG. 3 is a flowchart for making a microelectronic assembly, in an example embodiment.

FIG. 4 is a flowchart for using a microelectronic assembly, in an example embodiment.

FIGS. 5A-5K is a process flow for making a temperature sensor, in an example embodiment.

FIG. 6 is a block diagram of an electronic device incorporating at least one microelectronic assembly, in an example embodiment.

### DESCRIPTION OF EMBODIMENTS

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

While technology for incorporating temperature sensors in silicon dies and on PCBs is well established, positioning temperature sensors in other microelectronic assemblies, such as a chip package, may not be well established. In particular, placing one of a variety of conventional temperature sensors in a chip package may consume an impractical or inordinate amount of space within the chip package. Placing a conventional temperature sensor small enough to fit adequately within the chip package may be either overly expensive or inaccurate.

A temperature sensor within a chip package has been developed that provides relatively accurate temperature measurements while utilizing relatively minimal amounts of space. In particular, the temperature sensor may include a conventional trace, such as a copper trace, positioned such that the trace may move or resonate. The stresses induced in the trace due to temperature variations may cause changes in the resonant frequency of the trace. A magnetic field may be induced around the trace, such as with a magnet, and the mechanical vibration at resonance may be produced by sending a sinusoidal current through the trace. The resonant frequency may be determined, such as by measuring the induced electromotive force (voltage) due to the vibration, and changes in the resonant frequency may reflect changes in the temperature of the chip package proximate the trace.

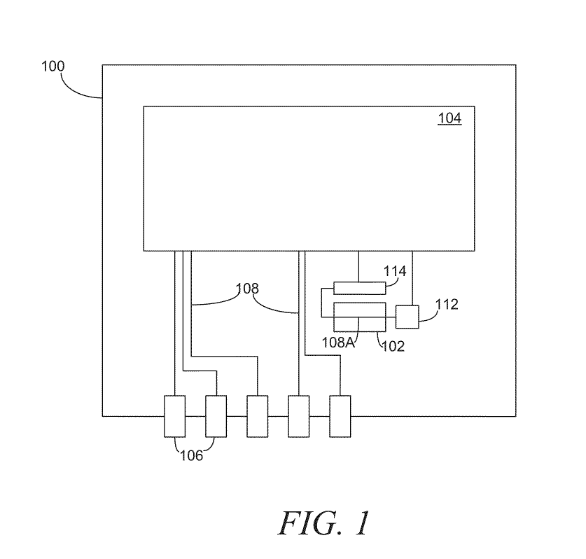

FIG. 1 shows an abstract microelectronic assembly 100 including a temperature sensor 102, in an example embodiment. In the illustrated example, the microelectronic assembly is a chip package, but the temperature sensor 102 may be applied in any of a variety of microelectronic assemblies. It is emphasized that the illustration of FIG. 1 is abstract, and components are not to scale and components on different layers of the microelectronic assembly 100 are illustrated together. It is to be recognized and understood that certain structural examples are illustrated herein with particularity.

The microelectronic assembly 100 includes one or more electronic components 104, such as a silicon die, input/output terminals 106, such as pads or pins, and traces 108 to conduct electrical signals throughout the microelectronic assembly 100. The traces 108 may be formed from copper or any other suitable electrically conductive materials. The various components 104, 106, 108 of the microelectronic assembly 100 may be formed in multiple layers that are obscured from this top-down view. The components 104, 106, 108 may be electrically and mechanically isolated with respect to one another with a dielectric material 110.

The temperature sensor 102 includes one of the traces 108A. The trace 108A is positioned with respect to other components of the temperature sensor 102, as will be detailed herein. The trace 108A may variously be coupled to a current source 112 that may be or include a frequency generator configured to produce a sinusoidal current of various, selectable frequencies. The current source may be included as a component of the microelectronic assembly 100 or may be positioned outside of the microelectronic assembly 100 and is accessible through a terminal 106. An frequency detection circuit 114, such as a phase locked loop, may be positioned as a component of or proximal and connected to the temperature sensor 102.

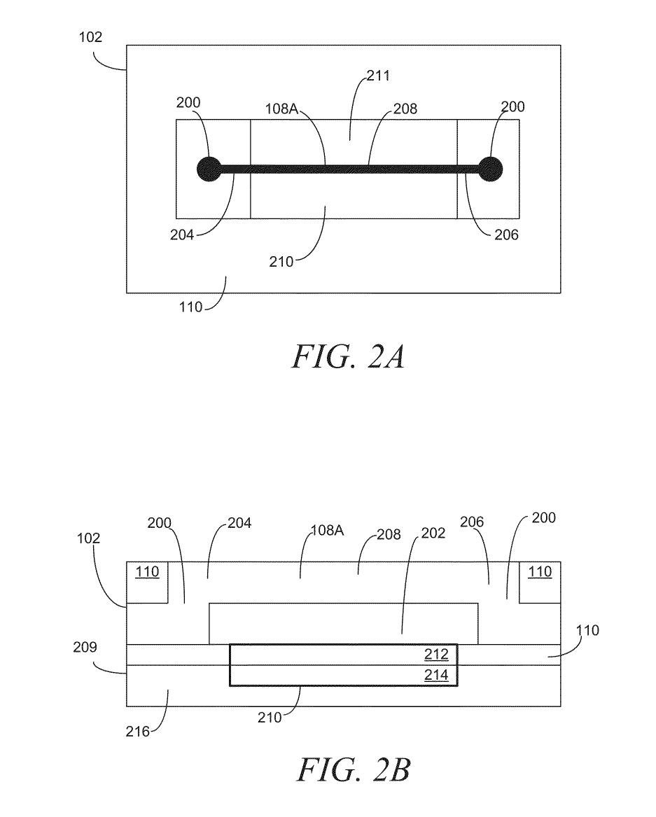

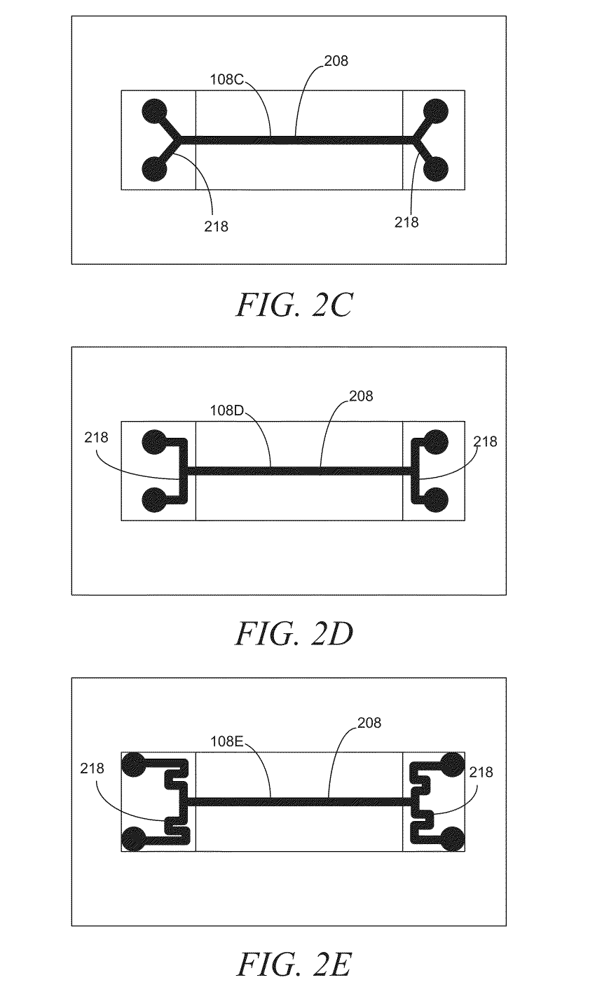

FIGS. 2A and 2B are top and side views of the temperature sensor 102, respectively, in an example embodiment. The temperature sensor 102 includes the trace 108A secured between mechanical anchors 200. The trace 108A is partially positioned within a cavity 202 formed in the dielectric material 110. The mechanical anchors thus substantially secure a first end 204 and a second end 206 of the trace 108A while leaving a center 208 of the trace 108A free to move laterally within the cavity 202 as the trace 108A resonates, as disclosed herein.

In the illustrated example, the mechanical anchors 200 are conductive vias. The anchors 200 may secure the first end 204 and the second end 206 with respect to a package layer 209 of the electronic assembly 100, as illustrated positioned below the trace 108A. The package layer 209 may be or may include a second conductive trace and, as a result, may be electrically coupled to the trace 108A with the mechanical anchors 200 when the mechanical anchors 200 are vias or otherwise include a conductive material.

A magnet 210 is positioned with respect to the cavity 202 to induce a magnetic field 211 within the cavity 202. In an example, the magnet 210 is a permanent magnet. Alternatively, the magnet 210 may be any magnet 210 that may produce a magnetic field 211, such as an electromagnet. As illustrated, a south pole 212 of the magnet 210 is positioned proximal the trace 108A and a north pole 214 of the magnet 210 is positioned distal the trace 108A, but alternative configurations are contemplated. The magnet 210 is embedded in a substrate layer 216 but may, in various examples, be attached to the substrate 216, such as by using surface mount techniques, or may otherwise be secured with respect to the electronic assembly 100 generally.

The cavity 202 may be formed according to various mechanisms. In an example, the dielectric material 110 is formed in a substantially complete layer and then dielectric material is removed to form the cavity 202. In an example, the dielectric material is removed to form the cavity 202 by using an etching technique. In an example, the etching technique is reactive ion etching, as disclosed in U.S. patent application Ser. No. 13/720,876, filed Dec. 19, 2012, U.S. patent application Ser. No. 14/141,875, filed Dec. 27, 2013, and U.S. patent application Ser. No. 13/618,003, filed Sep. 14, 2012, all of which are incorporated herein by reference in their entirety. Alternative methods of forming the cavity 202 may be utilized, such as by patterning then developing a photodefinable dielectric material or any other suitable method.

The temperature sensor 102 may operate by actuating the trace 108A electromagnetically using a sinusoidal or alternating current generated by the current source 112. The current as generated, in conjunction with the magnetic field 211 created by the magnet 210, may produce a Lorentz force that causes the trace 108A to vibrate within the cavity 202. The current source 112 may be adjusted, such as by sweeping over a frequency range, to output the current so that the frequency substantially matches the mechanical resonant frequency of the trace 108A to produce relatively large lateral displacements of the center 208 of the trace 108A within the cavity 202. The displacement of the center 208 of the trace 108A, in the presence of the magnetic field 211, may produce an induced electromotive force at the trace's 108A resonant frequency. The induced electromotive force may be detected by the frequency detection circuit 114.

When the temperature local to the trace 108A changes, and by extension the temperature of the trace 108A itself, the resonant frequency of the trace 108A may change as a function of thermomechanical stress in the trace 108A. The change in the resonant frequency is detectable in the induced electromotive force detected by the frequency detection circuit 114. The change in the resonant frequency of the trace 108A may then be correlated to the temperature change in the trace 108A and used to determine the local temperature.

The resonant frequency of the trace 108A may be a function of the trace 108A geometry and materials. The resonant frequency fᵣₑₛ of the trace 108A may be:

$${f}_{res} = \sqrt{\frac{{c}_{r} \frac{σ wt}{L} + {C}_{b} \frac{E {tw}^{3}}{{L}^{3}}}{m}}$$

L may be the length of the trace 108A between the anchors 200, w may be the width of the trace 108A, t may be the thickness of the trace 108A, and m may be the effective mass of the trace 108A. In an example, the trace has a length L of approximately seven hundred (700) micrometers, a width w of approximately nine (9) micrometers, and a thickness t of approximately fifteen (15) micrometers. Cᵣ and C_{b} may be constants for the trace 108A that may be determined empirically, such as by utilizing finite element analysis (FEA) techniques. σ may be the thermomechanical stress in the trace 108A, which is proportional to the change in temperature of the trace, with respect to a reference temperature T_{ref} at which the thermomechanical stress is zero. The above example dimensions may result in a resonant frequency in the range of tens of kilohertz. In an example, a trace 108A with the above example dimensions may have a baseline resonant frequency at zero thermomechanical stress of approximately fifty-nine (59) kilohertz. For the above dimensions, and for a trace 108A made of copper, changes in temperature as small as 0.1 degree Celsius may produce changes on the order of one hundred (100) Hertz in the resonant frequency of the trace 108A. Such frequency changes are detectable by the frequency sensing circuitry 114. The trace can be actuated with an AC current in the range of few milliamps (e.g., approximately five (5) or fewer milliamps) and consume a minimal amount of power (e.g., approximately two (2) or fewer microwatts).

FIGS. 2C-2E are top views of alternative trace geometries, in example embodiments. Such alternative traces 108C, 108D, 108E may be relatively less susceptible to buckling for relatively large temperature gradients than the straight trace 108A. The traces 108C, 108D, 108E include branches 218 near the anchors 200. The branches 218 may provide for reduced stress in the center 208 of the traces 108C, 108D, 108E, potentially allowing a larger temperature change to be detected before the traces 108C, 108D, 108E buckle in comparison with the trace 108A.

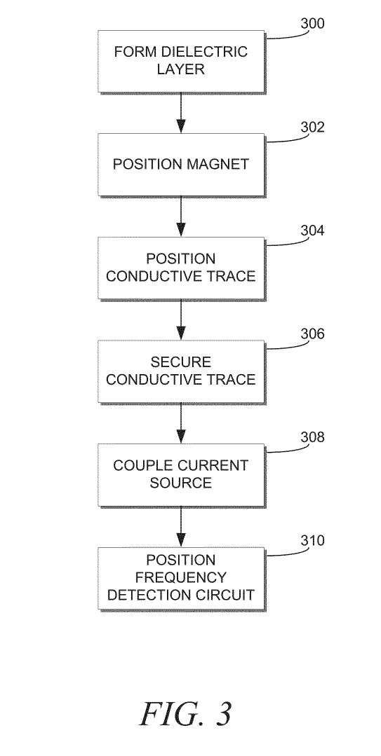

FIG. 3 is a flowchart for making a microelectronic assembly, in an example embodiment. The microelectronic assembly may be the microelectronic assembly 100 or may be any microelectronic assembly that includes a temperature sensor 102.

At operation 300, a dielectric layer having a cavity is formed. In an example, the cavity is formed by removing dielectric material. In an example, the dielectric material is removed using reactive ion etching.

At operation 302, a magnet is positioned to induce a magnetic field within the cavity.

At operation 304, a conductive trace is positioned, at least in part, within the cavity. The conductive trace resonates within the cavity based on a temperature-dependent resonant frequency of the conductive trace and a sinusoidal current induced through the conductive trace by a current source. The sinusoidal current induces a maximal electromotive force when a frequency of the sinusoidal current has an approximately equal magnitude to the temperature-dependent resonant frequency of the conductive trace. The maximal electromotive force, as induced, has a substantially equal frequency as the temperature-dependent resonant frequency of the conductive trace.

At operation 306, the conductive trace is substantially mechanically secured to a package layer at a first end by a first anchor and at a second end opposite the first end by a second anchor. In an example, mechanically securing the conductive trace includes positioning the first and second anchors to allow the conductive trace to move laterally as the conductive trace resonates. In an example, the first and second anchors are vias.

At operation 308, the current source is electrically coupled to the conductive trace through at least one of the vias.

At operation 310, a frequency detection circuit is positioned to detect the frequency of the maximal electromotive force as induced and produce an output proportional to a temperature of the conductive trace. In an example, the frequency detection circuit is a phase-locked loop.

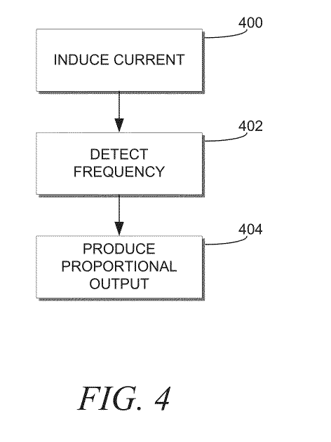

FIG. 4 is a flowchart for using a microelectronic assembly, in an example embodiment. The microelectronic assembly may be the microelectronic assembly 100 or may be any microelectronic assembly that includes a temperature sensor 102.

At operation 400, a current is induced with a current source through the conductive trace, the conductive trace being positioned, at least in part, within a cavity in a dielectric material, a magnet being positioned to induce a magnetic field within the cavity. The conductive trace resonates within the cavity based on a temperature-dependent resonant frequency of the conductive trace and a sinusoidal current induced through the conductive trace by a current source. The sinusoidal current induces a maximal electromotive force when a frequency of the sinusoidal current has an approximately equal magnitude to the temperature-dependent resonant frequency of the conductive trace. The maximal electromotive force, as induced, has a substantially equal frequency as the temperature-dependent resonant frequency of the conductive trace.

In an example, the conductive trace is substantially mechanically secured to a package layer at a first end by a first anchor and at a second end opposite the first end by a second anchor. In an example, the first and second anchors are positioned to allow the conductive trace to move laterally as the conductive trace resonates. In an example, the first and second anchors are vias. In an example, the current source is electrically coupled to the conductive trace through at least one of the vias. In an example, the conductive trace is comprised, at least in part, of copper.

At operation 402, the frequency of the electromagnetic force as induced is detected with a frequency detection circuit. In an example, the frequency detection circuit is a phase-locked loop.

At operation 404, an output proportional to a temperature of the conductive trace is produced with the frequency detection circuit.

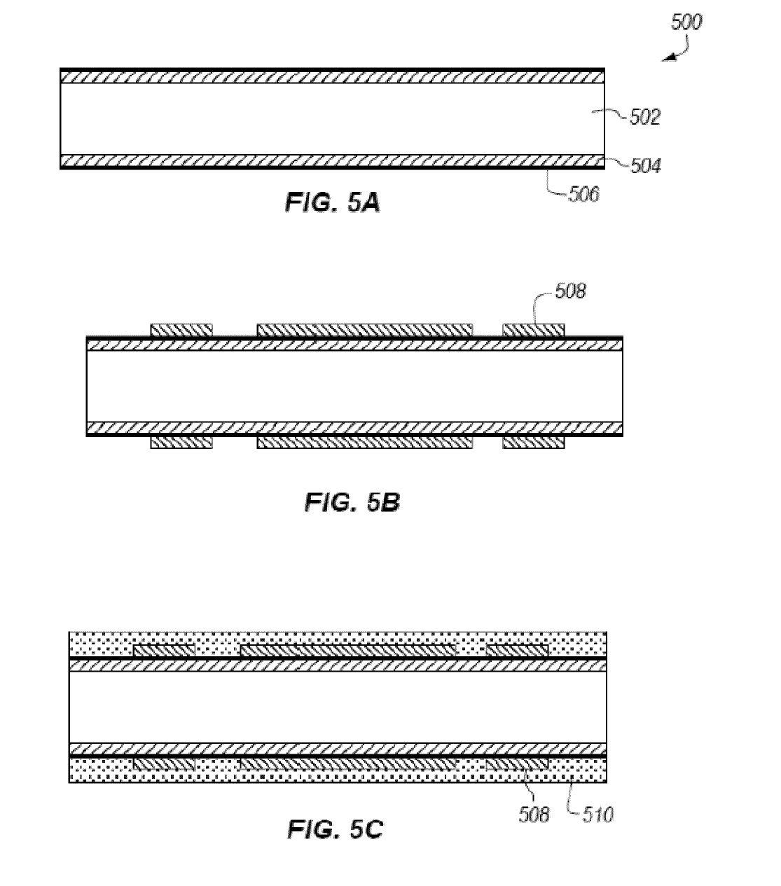

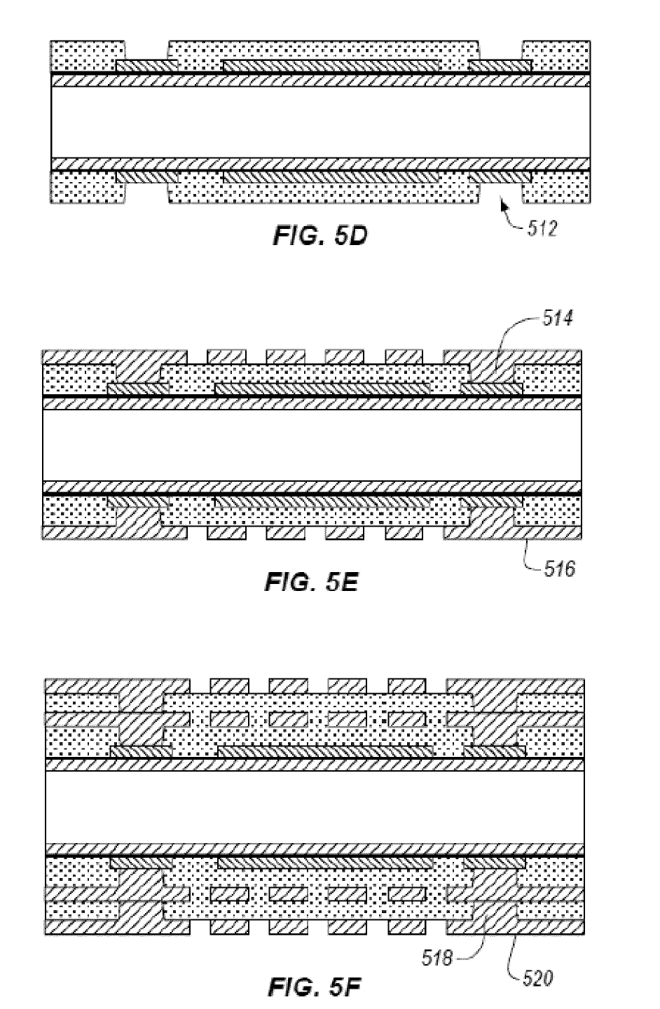

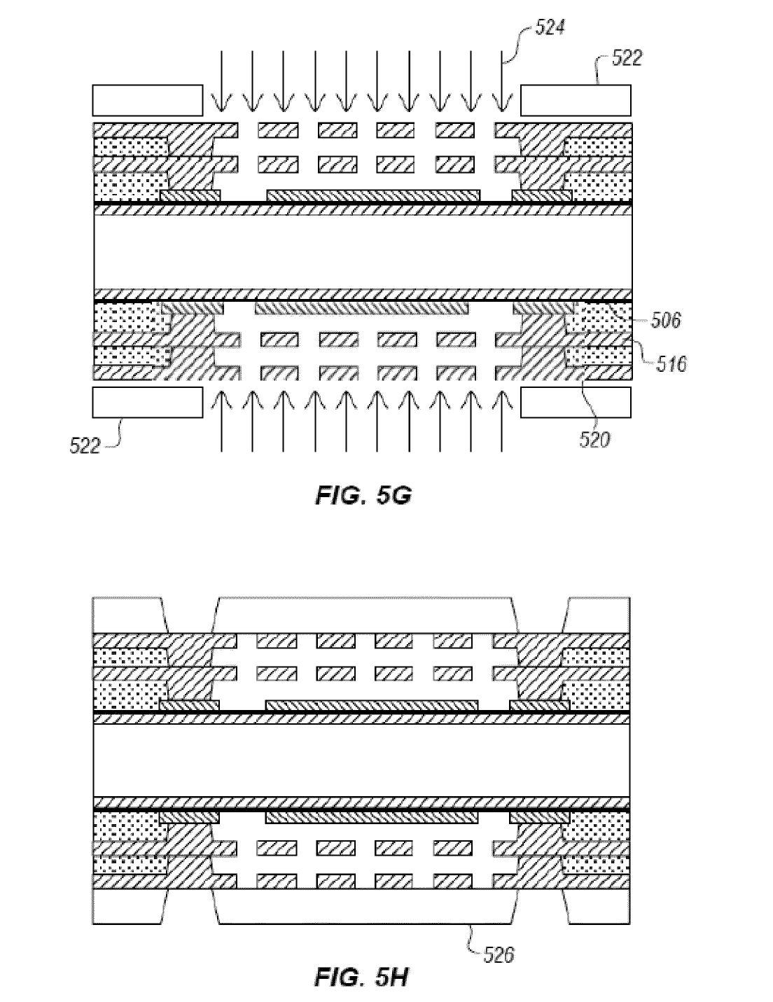

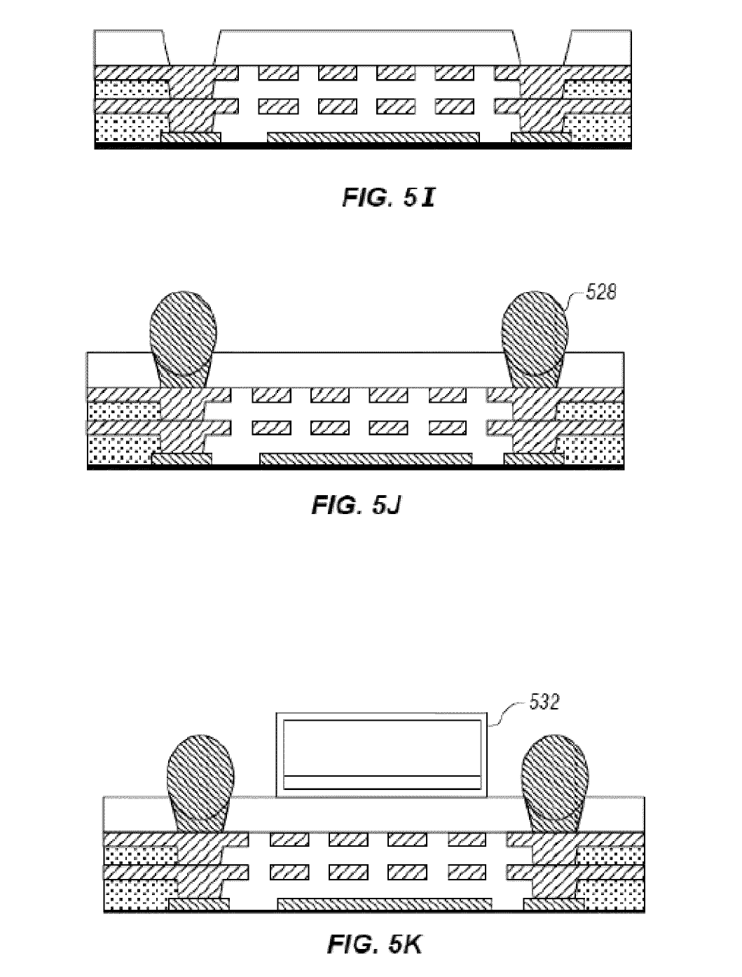

FIG. 5A is a side cross-sectional diagram that shows an example of the use of an incoming peelable core 500 for use in fabricating a temperature sensor in the package. The sensor may be fabricated using certain substrate processing techniques. The incoming peelable core has an organic carrier 502 at its center which is covered on both sides with a laminated copper foil 504 and a peelable copper layer 506. The copper layer 506 is weakly adhered to the laminated copper foil 504 so that the copper layer 506 can be peeled off after all the substrate fabrication processes are completed.

In FIG. 5B a dry film resist (DFR) pattern is used to apply copper plating according to a specific intended pattern. A pattern of lands 508 for routing layers and connections are formed on both sides of the core over the peelable Copper layer 506. In FIG. 5C a buildup layer 510 is laminated over the copper plating. In FIG. 5D laser etching is used to form valleys 512 in the buildup lamination. In FIG. 5E copper is applied into the valleys 512 to form vias 514 and a first metal layer 516 is applied over the buildup. The first metal layer 516 may contain the traces comprising the temperature sensor and may also include routing layers as desired to connect the temperature sensor with the vias and certain other components that are to be formed.

In FIG. 5F the operations of depositing buildup and patterning metal over the buildup are repeated with a second layer of dielectric 518 and a second metal layer 520 to form a mesh pattern over the dielectric and over the first metal layer 516.

In FIG. 5G a plasma mask 522 is applied on both sides of the structure and buildup etching 524 is applied to the structure. The mask determines which areas will be etched and the buildup in the exposed area is completely removed. This may provide for two metal layers 516, 520 with no or substantially no intervening materials. However, dielectrics remain in areas that were not exposed to the etching process.

In FIG. 5H a solder resist pattern 526 is applied over the etched areas to protect the metal mesh from other processes and to provide a structure for the sensor system. In FIG. 5I the peelable copper in the core has been removed to separate the top and bottom substrate portions on either side of the core.

In FIG. 5J solder bumps 530 are applied over the vias to connect external components to the first metal layer 516 and second metal layer 520. Alternatively any of a variety of other electrical technologies may be used to connect external components depending on the particular implementation. In FIG. 5K a magnet 532 has been placed over the first metal layer 516 and second metal layer 520 for use as described above in actuating the temperature sensor.

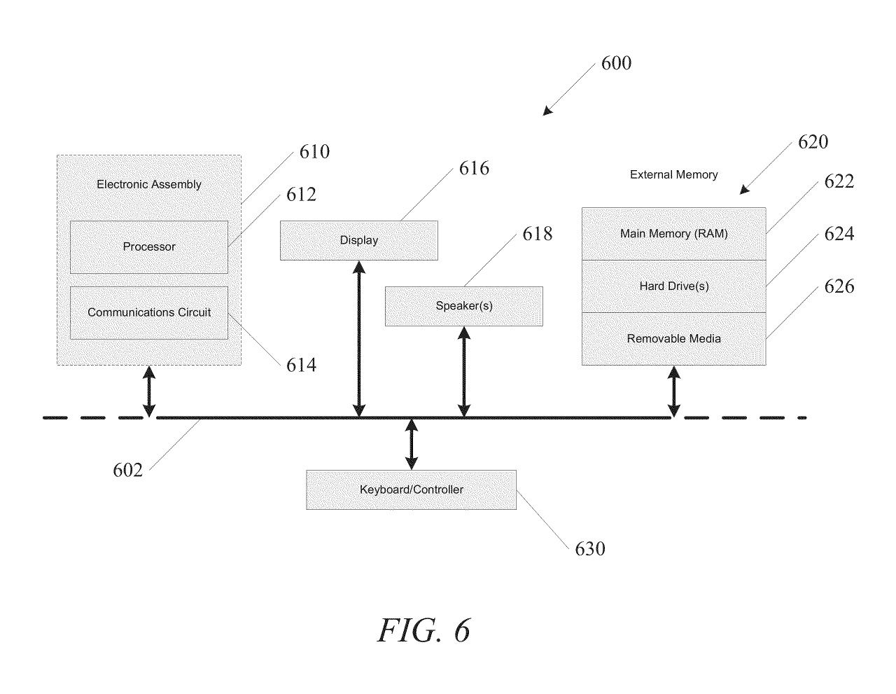

An example of an electronic device using electronic assemblies as described in the present disclosure is included to show an example of a higher level device application for the disclosed subject matter. FIG. 6 is a block diagram of an electronic device 600 incorporating at least one electronic assembly, such as an electronic assembly 100 or other electronic or microelectronic assembly related to examples herein. The electronic device 600 is merely one example of an electronic system in which embodiments of the present invention can be used. Examples of electronic devices 600 include, but are not limited to personal computers, tablet computers, mobile telephones, personal data assistants, MP3 or other digital music players, wearable devices, Internet of things (IOTS) devices, etc. In this example, the electronic device 600 comprises a data processing system that includes a system bus 602 to couple the various components of the system. The system bus 602 provides communications links among the various components of the electronic device 600 and can be implemented as a single bus, as a combination of busses, or in any other suitable manner.

An electronic assembly 610 is coupled to the system bus 602. The electronic assembly 610 can include any circuit or combination of circuits. In one embodiment, the electronic assembly 610 includes a processor 612 which can be of any type. As used herein, “processor” means any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, or any other type of processor or processing circuit.

Other types of circuits that can be included in the electronic assembly 610 are a custom circuit, an application-specific integrated circuit (ASIC), or the like, such as, for example, one or more circuits (such as a communications circuit 614) for use in wireless devices like mobile telephones, pagers, personal data assistants, portable computers, two-way radios, and similar electronic systems. The IC can perform any other type of function.

The electronic device 600 can also include an external memory 620, which in turn can include one or more memory elements suitable to the particular application, such as a main memory 622 in the form of random access memory (RAM), one or more hard drives 624, and/or one or more drives that handle removable media 626 such as compact disks (CD), digital video disk (DVD), and the like.

The electronic device 600 can also include a display device 616, one or more speakers 618, and a keyboard and/or controller 630, which can include a mouse, trackconnection, touch screen, voice-recognition device, or any other device that permits a system user to input information into and receive information from the electronic device 600.

### Additional Examples

Example 1 may include subject matter (such as an apparatus, a method, a means for performing acts) that can include a dielectric material forming a cavity, a magnet positioned to induce a magnetic field within the cavity, a conductive trace positioned, at least in part, within the cavity, and a frequency detection circuit configured to detect the frequency of the maximal electromotive force as induced and produce an output proportional to a temperature of the conductive trace. The conductive trace resonates within the cavity based on a temperature-dependent resonant frequency of the conductive trace and a sinusoidal current induced through the conductive trace by a current source, the sinusoidal current induces a maximal electromotive force when a frequency of the sinusoidal current has an approximately equal magnitude to the temperature-dependent resonant frequency of the conductive trace, and the maximal electromotive force, as induced, has a substantially equal frequency as the temperature-dependent resonant frequency of the conductive trace.

In Example 2, the electronic assembly of Example 1 optionally further includes that the conductive trace is substantially mechanically secured to a package layer at a first end by a first anchor and at a second end opposite the first end by a second anchor.

In Example 3, the electronic assembly of any one or more of Examples 1 and 2 optionally further includes that the first and second anchors are positioned to allow the conductive trace to move laterally as the conductive trace resonates.

In Example 4, the electronic assembly of any one or more of Examples 1-3 optionally further includes that the first and second anchors are vias.

In Example 5, the electronic assembly of any one or more of Examples 1-4 optionally further includes the current source, wherein the current source is electrically coupled to the conductive trace through at least one of the vias.

In Example 6, the electronic assembly of any one or more of Examples 1-5 optionally further includes that the frequency detection circuit is a phase-locked loop.

In Example 7, the electronic assembly of any one or more of Examples 1-6 optionally further includes that the conductive trace is comprised, at least in part, of copper.

Example 8 may include subject matter (such as an apparatus, a method, a means for performing acts) that can include forming a dielectric material having a cavity, positioning a magnet to induce a magnetic field within the cavity, positioning a conductive trace, at least in part, within the cavity, and positioning a frequency detection circuit to detect the frequency of the maximal electromotive force as induced and produce an output proportional to a temperature of the conductive trace. The conductive trace resonates within the cavity based on a temperature-dependent resonant frequency of the conductive trace and a sinusoidal current induced through the conductive trace by a current source, the sinusoidal current induces a maximal electromotive force when a frequency of the sinusoidal current has an approximately equal magnitude to the temperature-dependent resonant frequency of the conductive trace, and the maximal electromotive force, as induced, has a substantially equal frequency as the temperature-dependent resonant frequency of the conductive trace.

In Example 9, the method of Example 8 optionally further includes substantially mechanically securing the conductive trace to a package layer at a first end by a first anchor and at a second end opposite the first end by a second anchor.

In Example 10, the method of any one or more of Examples 8 and 9 optionally further includes that mechanically securing the conductive trace includes positioning the first and second anchors to allow the conductive trace to move laterally as the conductive trace resonates.

In Example 11, the method of any one or more of Examples 8-10 optionally further includes that the first and second anchors are vias.

In Example 12, the method of any one or more of Examples 8-11 optionally further includes electrically coupling the current source to the conductive trace through at least one of the vias.

In Example 13, the method of any one or more of Examples 8-12 optionally further includes that the frequency detection circuit is a phase-locked loop.

In Example 14, the method of any one or more of Examples 8-13 optionally further includes that forming the dielectric material includes forming the cavity by removing dielectric material.

In Example 15, the method of any one or more of Examples 8-14 optionally further includes that the dielectric material is removed using reactive ion etching.

Example 16 may include subject matter (such as an apparatus, a method, a means for performing acts) that can include inducing, with a current source, a current through the conductive trace, the conductive trace being positioned, at least in part, within a cavity in a dielectric material, a magnet being positioned to induce a magnetic field within the cavity, detecting, with a frequency detection circuit, the frequency of the electromagnetic force as induced, and producing, with the frequency detection circuit, an output proportional to a temperature of the conductive trace. The conductive trace resonates within the cavity based on a temperature-dependent resonant frequency of the conductive trace and a sinusoidal current induced through the conductive trace by a current source, the sinusoidal current induces a maximal electromotive force when a frequency of the sinusoidal current has an approximately equal magnitude to the temperature-dependent resonant frequency of the conductive trace, and the maximal electromotive force, as induced, has a substantially equal frequency as the temperature-dependent resonant frequency of the conductive trace.

In Example 17, the method of Example 16 optionally further includes that the conductive trace is substantially mechanically secured to a package layer at a first end by a first anchor and at a second end opposite the first end by a second anchor.

In Example 18, the method of any one or more of Examples 16 and 17 optionally further includes that the first and second anchors are positioned to allow the conductive trace to move laterally as the conductive trace resonates.

In Example 19, the method of any one or more of Examples 16-18 optionally further includes that the first and second anchors are vias.

In Example 20, the method of any one or more of Examples 16-19 optionally further includes that the current source is electrically coupled to the conductive trace through at least one of the vias.

In Example 21, the method of any one or more of Examples 16-20 optionally further includes that the frequency detection circuit is a phase-locked loop.

In Example 22, the method of any one or more of Examples 16-21 optionally further includes that the conductive trace is comprised, at least in part, of copper.

Each of these non-limiting examples can stand on its own, or can be combined with one or more of the other examples in any permutation or combination.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. An electronic assembly, comprising:
a dielectric material forming a cavity;
a magnet positioned to induce a magnetic field within the cavity;
a conductive trace positioned, at least in part, within the cavity, wherein:
the conductive trace resonates within the cavity based on a temperature-dependent resonant frequency of the conductive trace and a sinusoidal current induced through the conductive trace by a current source;
the sinusoidal current induces a maximal electromotive force when a frequency of the sinusoidal current has an approximately equal magnitude to the temperature-dependent resonant frequency of the conductive trace; and
the maximal electromotive force, as induced, has a substantially equal frequency as the temperature-dependent resonant frequency of the conductive trace; and
a frequency detection circuit configured to detect the frequency of the maximal electromotive force as induced and produce an output proportional to a temperature of the conductive trace.

2. The electronic assembly of claim 1, wherein the conductive trace is substantially mechanically secured to a package layer at a first end by a first anchor and at a second end opposite the first end by a second anchor.

3. The electronic assembly of claim 2, wherein the first and second anchors are positioned to allow the conductive trace to move laterally as the conductive trace resonates.

4. The electronic assembly of claim 2, wherein the first and second anchors are vias.

5. The electronic assembly of claim 4, further comprising the current source, wherein the current source is electrically coupled to the conductive trace through at least one of the vias.

6. The electronic assembly of claim 1, wherein the frequency detection circuit is a phase-locked loop.

7. The electronic assembly of claim 1, wherein the conductive trace is comprised, at least in part, of copper.

8. A method of making an electronic assembly, comprising:
forming a dielectric material having a cavity;
positioning a magnet to induce a magnetic field within the cavity;
positioning a conductive trace, at least in part, within the cavity, wherein:
the conductive trace resonates within the cavity based on a temperature-dependent resonant frequency of the conductive trace and a sinusoidal current induced through the conductive trace by a current source;
the sinusoidal current induces a maximal electromotive force when a frequency of the sinusoidal current has an approximately equal magnitude to the temperature-dependent resonant frequency of the conductive trace; and
the maximal electromotive force, as induced, has a substantially equal frequency as the temperature-dependent resonant frequency of the conductive trace; and
positioning a frequency detection circuit to detect the frequency of the maximal electromotive force as induced and produce an output proportional to a temperature of the conductive trace.

9. The method of claim 8, further comprising substantially mechanically securing the conductive trace to a package layer at a first end by a first anchor and at a second end opposite the first end by a second anchor.

10. The method of claim 9, wherein mechanically securing the conductive trace includes positioning the first and second anchors to allow the conductive trace to move laterally as the conductive trace resonates.

11. The method of claim 9, wherein the first and second anchors are vias.

12. The method of claim 11, further comprising electrically coupling the current source to the conductive trace through at least one of the vias.

13. The method of claim 8, wherein the frequency detection circuit is a phase-locked loop.

14. The method of claim 8, wherein forming the dielectric material includes forming the cavity by removing dielectric material.

15. The method of claim 14, wherein the dielectric material is removed using reactive ion etching.

16. A method of detecting a temperature of a conductive trace in an electronic assembly, comprising:
inducing, with a current source, a current through the conductive trace, the conductive trace being positioned, at least in part, within a cavity in a dielectric material, a magnet being positioned to induce a magnetic field within the cavity, wherein:
the conductive trace resonates within the cavity based on a temperature-dependent resonant frequency of the conductive trace and a sinusoidal current induced through the conductive trace by a current source;
the sinusoidal current induces a maximal electromotive force when a frequency of the sinusoidal current has an approximately equal magnitude to the temperature-dependent resonant frequency of the conductive trace; and
the maximal electromotive force, as induced, has a substantially equal frequency as the temperature-dependent resonant frequency of the conductive trace;
detecting, with a frequency detection circuit, the frequency of the electromagnetic force as induced; and
producing, with the frequency detection circuit, an output proportional to a temperature of the conductive trace.

17. The method of claim 15, wherein the conductive trace is substantially mechanically secured to a package layer at a first end by a first anchor and at a second end opposite the first end by a second anchor.

18. The method of claim 16, wherein the first and second anchors are positioned to allow the conductive trace to move laterally as the conductive trace resonates.

19. The method of claim 16, wherein the first and second anchors are vias.

20. The method of claim 18, wherein the current source is electrically coupled to the conductive trace through at least one of the vias.

21. The method of claim 15, wherein the frequency detection circuit is a phase-locked loop.

22. The method of claim 15, wherein the conductive trace is comprised, at least in part, of copper.
